(19) United States
(12) Patent Application Publication
(10) Pub. No.: US 2016/0056650 A1
(43) Pub. Date: Feb. 25, 2016

(54) Mobile Device Charger Bracelet

(71) Applicant: Kyle T. HALL, Harrisonburg, VA (US)

(72) Inventor: Kyle T. HALL, Harrisonburg, VA (US)

(21) Appl. No.: 14/832,472

(22) Filed: Aug. 21, 2015

Related U.S. Application Data
(60) Provisional application No. 62/040,289, filed on Aug. 21, 2014.

(51) Int. Cl. H02J 7/00; H04B 1/3883

(52) U.S. Cl. CPC H02J 7/0042; H04B 1/3883; H02J 7/0054; H02J 7/007; H02J 2007/0062

(57) ABSTRACT

A wearable battery operated recharger for charging and or powering a mobile device includes a band or a bracelet to be worn by a user, a charger assembly with rechargeable battery disposed within the band. The charge assembly is disposed within a compartment assessable through an exterior surface when the band is being worn. A wire connected to the recharging assembly has a dongle end for insertion into a mobile electronic device. The wire fits into the compartment and is selectively extendable outside of the component.

### CROSS-SECTION TO RELATED APPLICATION

This application claims the benefit of U.S. Provisional Patent Application Ser. No. 62/040,289, filed Aug. 21, 2014, here incorporated by reference.

### FIELD OF THE INVENTION

The present invention relates to a mobile device charger and in particular a mobile device charger in the form of a bracelet or band with internal battery and dongle end adapted to fit into a mobile device such as a mobile/cellular telephone, music player, tablet, camera and alike. Advantageously, the mobile device charger recharges and/or powers the mobile device by plugging the dongle end into the mobile device which charges and/or powers the mobile device using the band's internal battery.

### BACKGROUND OF THE INVENTION

In ever increasing numbers, people are carrying personal mobile electronic devices. These devices include mobile telephones or cellular phones, portable music players such as iPods®, various sizes of tablet computers, and cameras. Each of these mobile electronic devices has its own internal battery for powering the device. Depending on the device and its use, the internal battery produces a finite duration of power before the mobile device needs to be recharged. Often, mobile devices become inoperative due to low battery life at times when one is not able to connect the mobile device to a recharger. In some instances, a person may not have a cable with him or her to plug into the mobile device to connect the mobile device to a power supply such as a USB port, car 12V socket or other power source.

Recently, developments in personal mobile electronic device accessories include a wearable band for recharging or powering personal electronic mobile devices in which the band has its own internal rechargeable battery and a port for connecting a cable between the band and an electronic device to recharge or power the mobile electronic device. One example is described in U.S. Pat. No. 8,624,554 in which a plug end (48) of an adapter (42) is disposed in a compartment of a bracelet exposed to the wrist of a user when worn, as shown in its FIG. 2.

Another recent device is described in U.S. Pat. No. 8,459,825 which discloses a band having internal batteries and a USB connector for connecting the band to a USB port for recharging the internal battery of the band. A separate cable from the ban is plugged in a charging port of the band on one end and a mobile electronic devise on the other, to charge the mobile device.

### SUMMARY OF THE INVENTION

The present invention relates to a wearable band or bracelet with internal battery for recharging and/or powering a personal mobile electronic device. The bracelet or band, in one form, includes one or more internal batteries, a charging assembly connected to the internal battery/batteries and a wire for connecting the charging assembly to a mobile electronic device. The wire has a first end connected to the charging assembly and a second, dongle (male) end, for insertion into the charging/adapter port of the electronic device for charging the electronic device, when connected.

The dongle end has a male connector for insertion into a complementary female charging port of a mobile electronic device to be charged or powered using the internal battery/batteries of the band/bracelet. The dongle male end connector can be a iPhone/iPad/iPod, 9-pin connector THUNDERBOLT® cable end, a micro-USB plug end or and mini-USB plug end for insertion into an electronic device having the commentary female charging port.

The wearable band or bracelet has a charging port, such as a female connector for use in charging the internal battery of the band. The female connector can be any conventional connector such as, but not limited to a mini-USB port connector, micro-USB connector, or iPhone/iPad/iPod, 9-pin connector known as a THUNDERBOLT® port. The charging port/female connector receives a male end from a power cable to recharge the internal battery of the band. For example, the female connector may be a mini-USB port or micro-USB port which receives the male end from a mini-USB/micro-USB cable (respectively) connected to a power supply such as one found on a computer, a 12V car adapter or a charging station USB port, such as those found in airport terminals, convention centers and even some home power outlets. Accordingly, a power adapter, e.g. a USB mini-connector cable plugged into an 110V/220V outlet or a car outlet can be used to recharge the internal battery or batteries in the band/bracelet.

In use, the male connector (dongle end) is electrically connected to a complementary electrical interface port of an electrical device, such as, but not limited to, a mobile phone, portable music device, tablet, or camera, to charge the internal battery of the mobile device. The bracelet may be worn on a person's wrist or ankle when not being used to recharge the battery and/or, power the mobile device.

In one advantageous form, the male connector is the end of a wire/cable attached to the band which allows the cable to be extended away from the band to allow the male end to more easily be plugged into a mobile electronic device to recharger and/or power the device. The wire/cable is placed/pushed back into the band when the connector is not in use to charge/power the personal mobile electronic device.

In one advantageous form, the band has a compartment accessible from a top, exterior surface of the band for easy access to the cable, disposed therein, even while the band is on ones wrist.

The present invention, in one form thereof, relates to a wearable battery operated recharger for charging and or powering a mobile electronic device. The recharger includes a band to be worn by a user, a charging assembly with rechargeable battery disposed within a compartment formed in an exterior facing surface of the band, opposite an interior facing surface which is adjacent ones wrist when being worn thereon. A wire has a dongle end and an opposite end connected to the charging assembly. The wire flexibly extends from the compartment and is adapted to selectively connect to a mobile electronic device for charging and/or powering the electronic device when connected to the mobile electronic device. In one further form, the recharger has a charging port connected to the charging assembly for charging the chargeable battery. In another advantageous form, the band is composed of a flexible material. The flexible material may include but not limited to a textile material such as nylon, a polymeric material, polypropylene, polyvinyl chloride (PVC) blend, rubber or silicone etc.

In yet another form, the band comprises two ends joined together via a strap. For example, a strap formed form two segments, one segment attached to two ends of a band respectively may be joined together in the middle via a clasp, thereby forming a complete loop from the band and strap segments. The strap can be made of nylon, cotton and may be a textile.

Present invention in another form thereof, relates to a wearable battery operated recharger for charging and/or powering an electronic device. The charger includes a bracelet to be worn by a user, a charging assembly with rechargeable battery disposed within the bracelet and a wire disposed in a compartment accessible from an exterior facing surface of the bracelet, opposite an interior or wrist facing of the bracelet. The wire has a first end connected to the charging assembly and a second end in the form of a dongle end opposite of the first end. The wire is flexibly extendable from the compartment and is adapted for selective connection to a mobile electronic device for charging and/or powering the electronic device when connected thereto.

The bracelet in one advantageous form is open having a gap between two bracelet ends.

In an alternative advantageous form, the bracelet may have a first strap attached to one end of two bracelet ends and a second strap attached to a second end of the bracelet. The first strap and second strap are drawn together via a clasp to form a closed loop formed from the bracelet, the first strap and the second strap.

### BRIEF DESCRIPTION OF THE DRAWINGS

FIG. 1 is a perspective view of charger bracelet shown with its clasp fastened and outer cover open in accordance with the present invention.

FIG. 2 is another perspective view of the charger bracelet of FIG. 1.

FIG. 3 is a perspective view of the charger of FIG. 1 shown with the outer cover closed in accordance with the present invention.

FIG. 4 is a perspective view of the charger bracelet of FIG. 1 shown with its outer cover closed and bracelet strap unfastened from a clasp of the bracelet in accordance with one aspect of the present of invention.

FIG. 5 is a perspective view of another charger bracelet in accordance with another aspect of the present invention shown with its outer cover open.

FIG. 6 is the bracelet of FIG. 5 shown with its outer cover closed.

FIG. 7 is a perspective view showing the charger bracelet of FIG. 1 with a mobile electronic device to be charged or powered by the charger bracelet in accordance with the present invention.

### DETAILED DESCRIPTION

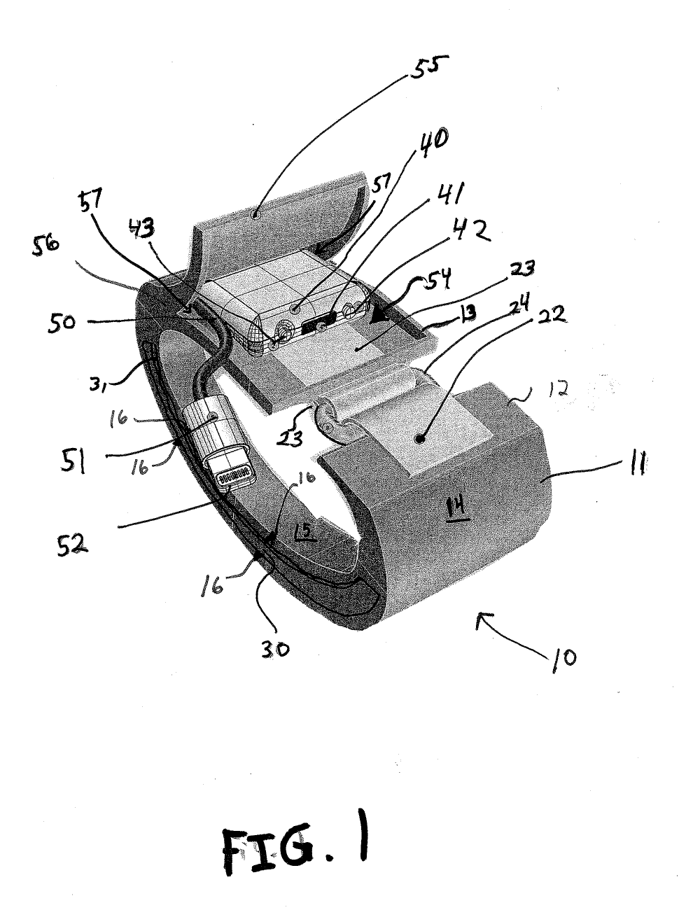

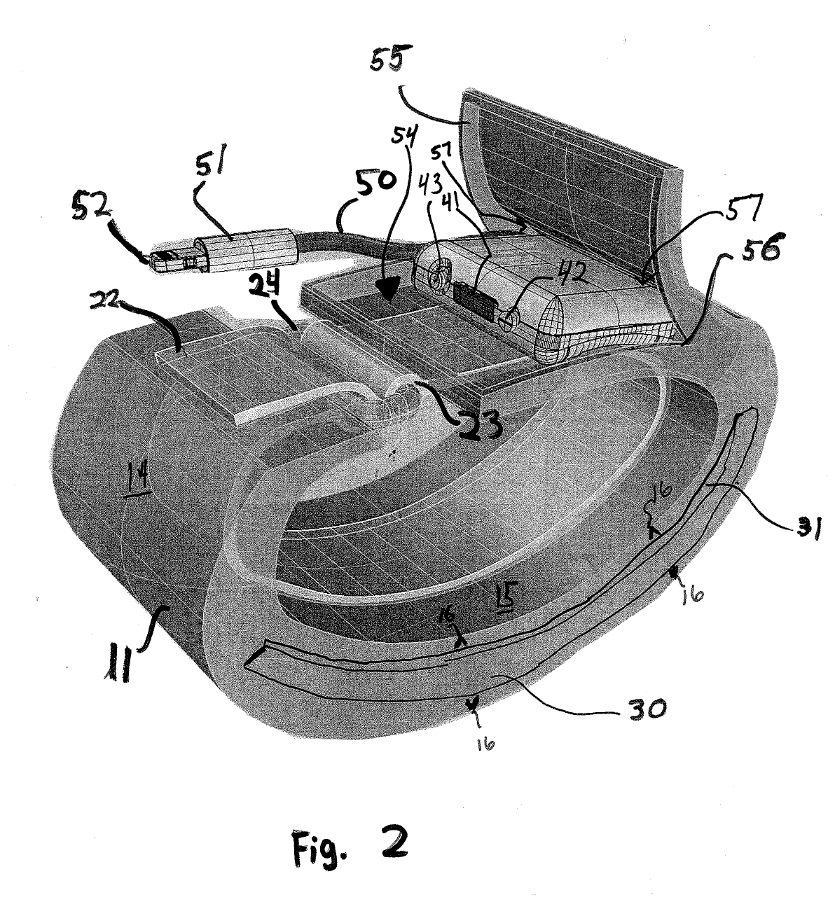

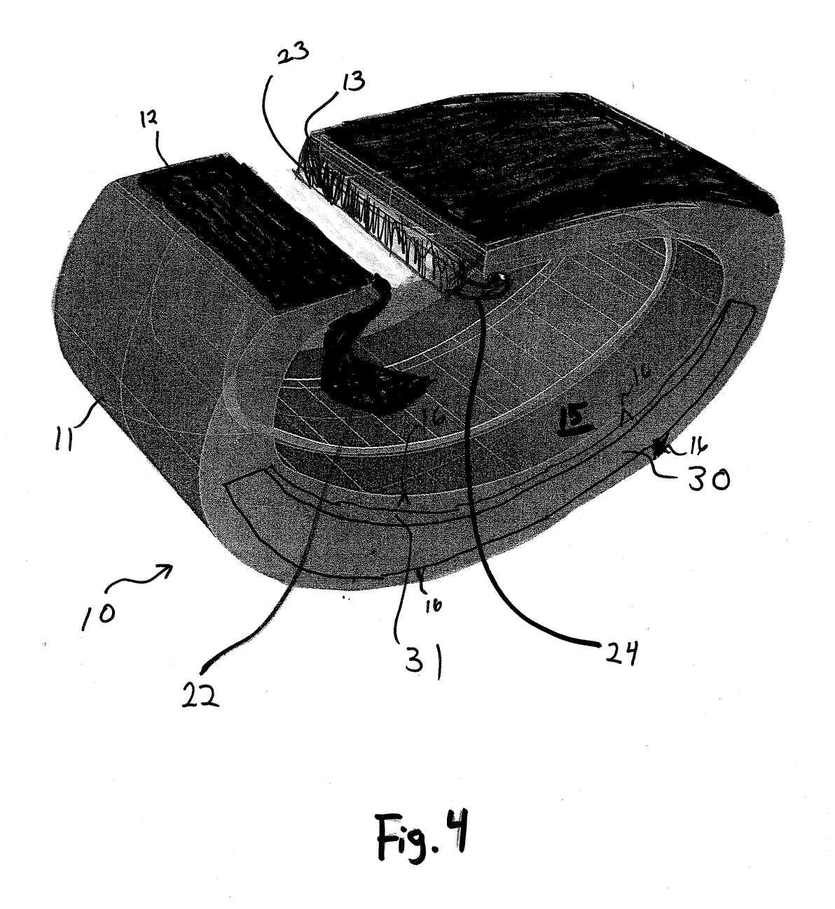

The present charger band or bracelet will now be described in detail with reference to the drawings. Referring specifically to FIGS. 1-4, a charger bracelet or band in accordance with the present invention is shown as bracelet 10. Bracelet 10 has a main body 11 composed of a flexible material such as a polymer or polymeric material, a rubber material, silicone, nylon or polypropylene or a PVC blend. The band body 11 has ends 12, 13, an exterior facing surface 14 and an interior facing surface 15 which faces the wrist of a wearer when worn.

Material of main body 11, is thinned in a series areas along its length which provides a series of hinge-like pivot points 16, allowing the main body 11 to bend and be more flexible.

Straps 22, 23 attached to ends 12, 13, respectfully. Strap 23 is permanently affixed to clasp 24 and strap 22 is selectively inserted through clasp 24 for removable joining strap 22 to clasp 24 thereby forming a complete loop from the bracelet main body 11, and straps 22, 23 with clasp 24. In one advantages form, a loop and fastener such as VELCRO® or a generic version may be used to secure strap 22 to a portion of the bracelet main body 11.

One or more rechargeable batteries such as battery 30 is disposed within the body 11. The rechargeable battery 30 can be a single battery or it can be composed of a series of batteries connected together.

The rechargeable battery 30 is connected to a printed circuit board assembly of a charging assembly 40. A flexible wire or cable 50 is connected to the recharging assembly 40. The wire 50 has a dongle end 51 with a male connector end 52 for insertion into a complementary female port for power or recharging a mobile electronic device using the battery 30. Insulation 31 such as PVC separates battery 30 from an interior facing 15.

The charging assembly 40 includes a female charging port 41. The female charging port 41 can be a micro-USB or mini-USB female charging port. Connecting a complementary male end of the cable to the female charging port 41 allows one to recharge the rechargeable battery 30. Charging indicator 42 illuminates when dongle male end 52 is inserted into a corresponding female port of an electronic device thereby indicating that the bracelet 10 is powering and/or charging the electronic device.

Charging switch 43 selectively turns on and off an electrical connection between the rechargeable battery 30 and the recharging assembly 40.

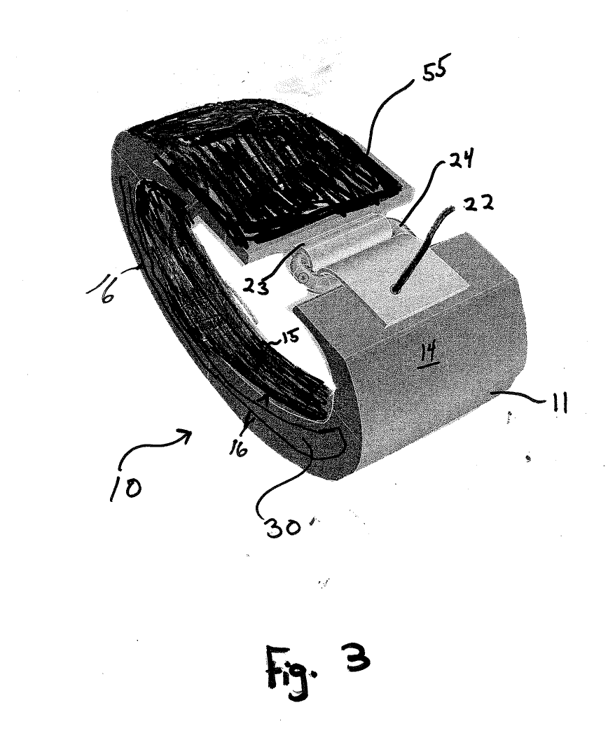

The wire or cable 50 with dongle 51 end and 52 fits inside compartment 54. A cover 55 is selectively removable from an opening to allow access in to compartment 54. FIG. 1 shows the cover 55 in its open position which bends at a pivot point 56 to the remaining portion of the body 11 based on the flexible material of the body 11 so that when the wire/cable 50 with dongle and 51 is within the compartment 54, the cover 55 can be closed as shown in FIG. 3. Further, the flexible material allows the cover 55 to be flexibly separated from the remaining portion of body 11 to gain access to compartment 54 and to then close covering the recharging assembly 40 and wire 50 with dongle and 51 (FIG. 3). Advantageously, the cover 54 can be composed of a flexible material, such as neoprene, which seals the cover 55 around the opening to the compartment 54, to produce a water-resistant seal or moistures/sweat resistant seal. This reduces the opportunity of water, moisture or sweat from entering into component 54 and possibly affecting the electronics of the charging assembly 40.

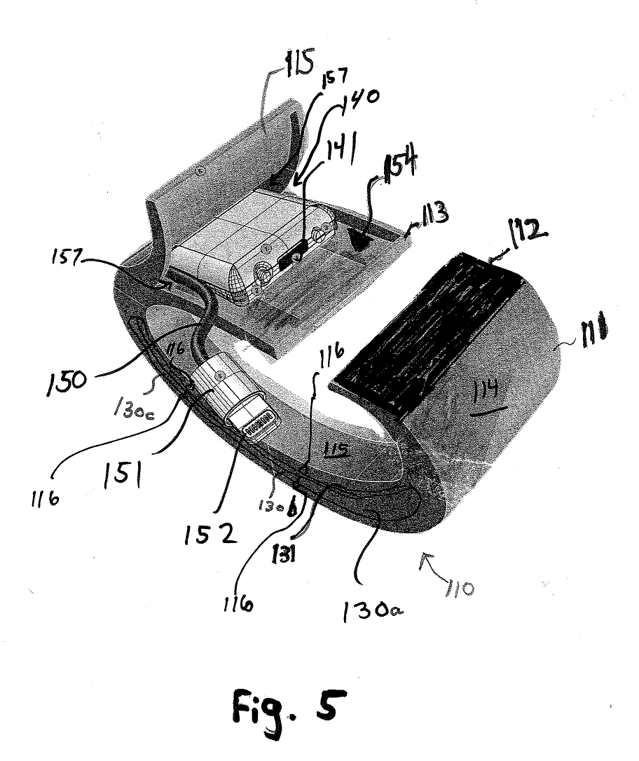

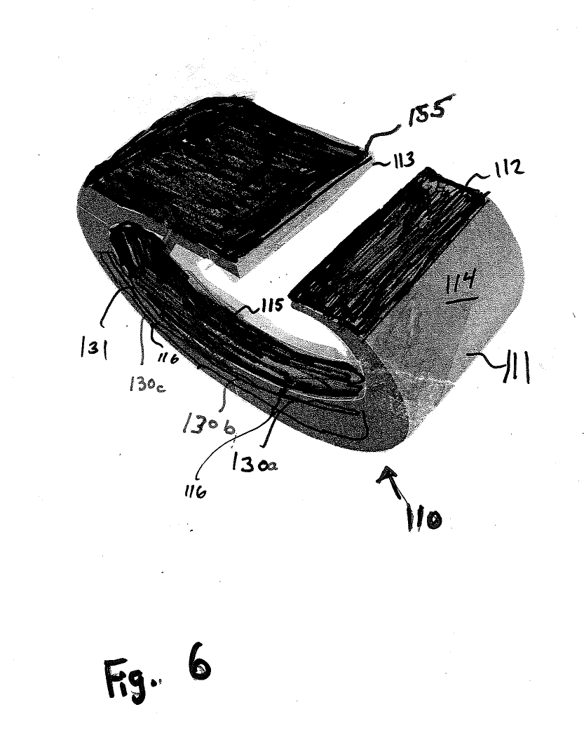

Referring now to FIGS. 5 and 6, band 110 is another embodiment of the chargeable bracelet in accordance with the present invention. Like elements to those in the embodiment to FIG. 1 have been raised by 100. One difference between the bracelet 110 from bracelet 110 is the absence of straps joining end 112 and end 113. Band 110 is sufficiently rigid to allow the band to remain in place when worn by a user. However, absent the straps, the bracelet 110 is an open bracelet or band rather than a closed bracelet or band of bracelet 10.

In bracelet 110, a series of three batteries, 130a, 130b, 130c provide power for charging/powering a mobile electronic device. However, a single battery like battery 30 can be used instead of the three separate ones. Similarly, in band 10, three batteries can be used instead of the single, battery 30.

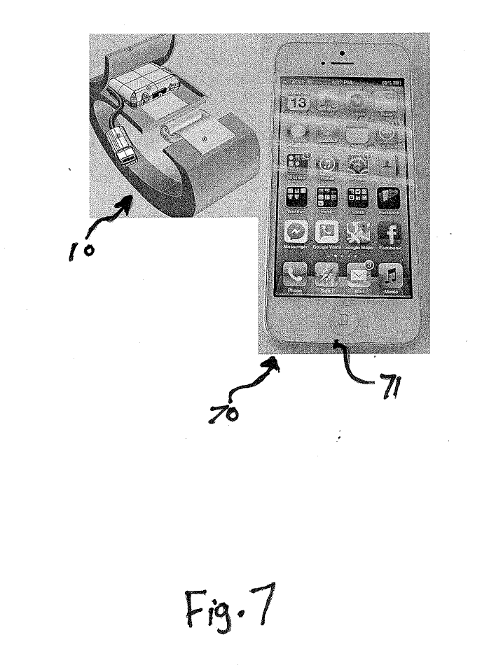

Referring now to FIGS. 5 and 7, along with FIG. 1, the bracket/band has a male plug end 52, 51 for connecting the band 10, 110 to a mobile electronic device. As shown, the plug is a 9-pin male end designed to fit in a compatible Apple® device such as an iPhone/iPod/iPad device 70. Alternatively, the male plug end, rather than being a 9-pin end, can be any suitable plug end to fit in other compatible electronic devices such as a mini-USB end on micro-USB end.

In use, bracelet/band 10, 110 powers or recharges a mobile electronic device such as mobile electronic device 70 by inserting the dongle end 52, 152 into the female power port 71. Advantageously, the wire 50 is flexible and extends away from the body 11, 111 and the recharging assembly 40 (e.g. FIG. 1) to easily insert the dongle end 52, 152 into port 71. When not in use, the wire 50 with dongle 51, 151 can be pushed into compartment 54, 154 and cover 55, 155 shut.

In order to maximize the size and capacity of power, in terms of milliamps, the band has a battery which extends within a substantial portion of the band, for example approximately 50% as shown. The battery may be curved as shown in the Figures or the battery may be substantially planar, e.g. rectangular in shape. The battery is connected to a charging board which in turn is connected to an input port such as a mini-USB input port. Advantageously, the battery 30 is between 1200 mAh and 4400 mAh.

To recharge the battery 30,130 of the band 10,110, a person inserts a male end of a complementary cable end, for example a male mini-USB plug, into a USB input charging port p.g. changing port 41,141 of the band 10, 110 and then plugs the other end of the cable into a wall outlet, USB power port or 12V car socket in order to recharge the internal battery30, 130 of the band 10, 110.

Advantageously, the separation of battery 30, 130 via installation 31, 131 limits heat transfer between battery 30, 131 and interior surface 134 of the band 10, 110. As a result, heat from the battery 30, 130 is retarded and limits applying heat to one's body e.g. wrist or ankle, when worn.

A further feature is provided by a water-resistant seal form between the cover 55, 155 and the remaining portion of the body 11, 110 of the band 10, 110. This limits moisture, water and sweat from entering compartment 54, 154 which would otherwise possibly harm components of the charging assembly 40, 140 dongle 151. In addition, the battery 30, 130 is encased within a PVC material and disposed within the body 11, 111 separating the battery from the outside environment. Further, a seal between compartment 54, 154 at rear portion 57, 157, around the changing assembly 40, 140 and wire 50, 150 prevents or limits water or moisture from passing between compartment 54, 154 and an interior portion of the band 11, 111 where the battery 30, 130 is disposed. As a result, one can wear the band 10, 110 during activities in which the band may encounter water or moisture such as sporting events and the like.

A further advantage of the present band 10, 110 is its charging compartment 54, 154 being accessible from the exterior facing surface 14, 114 rather than interior surface 15, 115 (wrist side). The location of compartment 54, 154 allows one to access the compartment (54, 154 when the band 10, 110 is attached to a user, allowing one to access the dongle end 51, 151 and other component of the charging assemble 40, 140. In addition, since the compartment 54, 154 is accessible on the exterior facing surface 14 , 114 rather than interior facing surface 15, 115, sweat and moisture from a user's skin touching the surface 15, 115 does not have a means for easy transfer into the compartment 54, 154.

It will be clear to one of ordinary skill in the art will recognize that many different adaptations can be made to the design of the band while keeping within the scope and purpose of this disclosure. For example, the band can be made out of various different materials including but not limited to metal, plastics and composite material. In addition, the band can be made in a variety of different colors, sizes, widths, diameters, etc. Further, the band may have designs or textures rather than being a smooth surface as shown in the figures of the present disclosure.

It will now be clear that the present invention provides features and advantages not found in prior known compositions and treatments. Further, one of ordinary skill in the art will recognize that aspects of the present disclosure can be modified using routine techniques consistent with the present disclosure.

1. A wearable battery operated recharger for charging a mobile electronic device;
comprising:
a band adapted to be worn by a user, the band having an interior facing surface to be disposed adjacent the skin of a user and an exterior facing surfacing facing away from a user, when the band is being worn;
a compartment accessible from the exterior facing surface;
a recharging assembly with rechargeable battery disposed within the compartment; and
a wire having a first end connected to the recharging assembly and the wire having a dongle end, opposite the first end, the wire flexibly extendable from the compartment and adapted for selective connection to a mobile electronic device, for charging the electronic device, when connected thereto.

2. The wearable battery operated recharger of claim 1, further comprising:
a charging port connected to the recharging assemble for charging the rechargeable battery.

3. The wearable battery operated recharger of claim 2, wherein the charging port receives a cable for recharging the rechargeable battery.

4. The wearable battery operated recharger of claim 1, wherein the band in composed of a flexible material.

5. The wearable battery operated recharger of claim 1, wherein the band is openable via a releasable clasp.

6. The wearable battery operated recharger of claim 1, wherein the band comprises two end joined together via a strap.

7. The wearable battery operated recharger of claim 6, wherein the band comprises two ends joined together via a strap.

8. The wearable battery operated recharger of claim 7, wherein the strap comprises two segments, one of the two segments attached to one of the two band ends and a second one of the two segments attached to a second one of the two band ends, the two segments joined together via a clasp.

9. The wearable battery operated recharger of claim 1, further comprising an indicator light, said indicator light illuminates when the wire is connected to, and is charging a mobile electronic device.

10. The wearable battery operated recharger of claim 1, wherein the wire extends away from the recharging assembly and is insertable into a mobile electronic device for charging the electronic device without opening or separating the band.

11. The wearable battery operated recharger of claim 1, wherein the rechargeable battery has a capacity of between 1200 mAh to 4400 mAh.

12. The wearable battery operated recharger of claim 1, wherein a cover is removably disposed over an opening in the exterior facing surface to provide access to the compartment through the exterior facing surface, the cover forming a tight seal around the opening.

13. The wearable battery operated recharger of claim 12, wherein the tight seal is a water tight seal.

14. A wearable battery operated recharger for charging a mobile electronic device; comprising:
a bracelet adapted to be worn by a user; the bracelet adapted to be worn by a user, the bracelet having an interior facing surface to be disposed adjacent the skin of a user and an exterior facing surfacing facing away from a user, when the bracelet is being worn;
a compartment accessible from the exterior facing surface;
a recharging assembly with rechargeable battery disposed within the compartment; and
a wire having a first end connected to the recharging assembly and the wire having a dongle end, opposite the first end, the wire flexibly extendable from the compartment and adapted for selective connection to a mobile electronic device, for charging the electronic device, when connected thereto.

15. The wearable battery operated recharger of claim 14, wherein the bracelet is an open bracelet having a gap between two respective bracelet ends.

16. The wearable battery operated recharger of claim 14, wherein a first strap is attached to one of the bracelet ends and a second strap is attached to a second of the bracelet ends, the first strap and second strap joined together via a clasp, to form a closed loop formed from the bracelet the first scrap and the second strap.

17. The wearable battery operated recharger of claim 14, further comprising:
a charging port connected to the recharging assemble for charging the rechargeable battery.

18. The wearable battery operated recharger of claim 17, wherein the charging port receives a cable for recharging the rechargeable battery.

19. The wearable battery operated recharger of claim 14, wherein the band in composed of a flexible material.

20. The wearable battery operated recharger of claim 14, further comprising an indicator light, said indicator light illuminates when the wire is connected to, and is charging a mobile electronic device.

21. The wearable battery operated recharger of claim 14, wherein the wire extends away from the recharging assembly and is insertable into a mobile electronic device for charging the electronic device without opening or separating the band.

22. The wearable battery operated recharger of claim 14, wherein the rechargeable battery has a capacity of between 1200 mAh to 4400 mAh.

23. The wearable battery operated recharger of claim 14, wherein a cover is removably disposed over an opening in the exterior facing surface to provide access to the compartment through the exterior facing surface, the cover forming a tight seal around the opening.

24. The wearable battery operated recharger of claim 14, wherein the tight seal is a water tight seal.
